(19) United States
(12) Patent Application Publication
(10) Pub. No.: US 2026/0125201 A1
(43) Pub. Date: May 7, 2026

(54) LANDSCAPE EDGING SYSTEM

(71) Applicant: Avon Plastics, Inc., Paynesville, MN (US)

(72) Inventors: Nicholas Demuth, II, Sartell, MN (US); Mark T. Reum, Avon, MN (US); Nicholas J. Demuth, Cold Spring, MN (US)

(21) Appl. No.: 19/380,648

(22) Filed: Nov. 5, 2025

Related U.S. Application Data
(60) Provisional application No. 63/716,719, filed on Nov. 5, 2024.

(51) Int. Cl. B65D 85/671; A01G 9/28; B65D 71/02

(52) U.S. Cl. CPC B65D 85/671; A01G 9/28; B65D 71/02

(57) ABSTRACT

A landscape edging system provides a plurality of stakes in an assembly that can be packaged together with a coil of landscape edging. The stake assembly includes a plurality of stakes joined together by connector segments. Support arms of the stake assembly terminate in posts to support the stakes atop the coil of edging. Centering brackets connected to the posts function to keep the stakes centered atop the coil of edging. A plurality of bands secure the stake assembly atop the coil of edging and keep the coil of edging from unraveling.

### PRIORITY

This Application claims priority to and the benefit of U.S. Provisional Patent Application No. 63/716,719, filed November 5, 2024, which is incorporated fully herein by reference.

### FIELD

The present invention generally relates to landscape products, and more particularly to landscape edging packaged with corresponding stakes.

### BACKGROUND

Landscape edging is typically used to edge lawns, gardens and other landscape features. Such edging is generally ribbonlike and formed from a plastic material. A length of such, such as 20, 24, 40 or 50 feet for example, is often packaged in a roll or coil.

It is necessary to secure the edging after installation with a plurality of stakes driven into the ground. In retail displays, suitable stakes are generally displayed adjacent to the packages of coiled edging. However, it still happens that the customer does not purchase the stakes or does not purchase the correct quantity for the length of coil that they purchased.

### SUMMARY

The present invention addresses the problems noted above by providing a landscape edging system, kit, apparatus and method that includes the required stakes with the edging in a singular package. A stake assembly is formed so that the plurality of stakes can be packaged together with the coil of edging. The stake assembly includes a plurality of stakes joined together by connector segments. The stake assembly includes support arms terminating in posts to support the stakes atop the coil of edging. Centering brackets connected to the posts keep the stakes centered atop the coil of edging. A plurality of bands secures the stake assembly atop the coil of edging and keeps the coil of edging from unraveling.

Disclosed herein is a landscape edging system, which also can be provided as a kit. The system or kit includes a length of landscape edging formed into a coil with a hollow center and a stake assembly secured to the coiled length of landscape edging. The stake assembly can comprise a plurality of stakes joined together by connector segments spanning between adjacent stakes in the plurality of stakes. A plurality of support arms can extend outwardly from the joined together plurality of stakes. Each support arm is joined on a proximal end thereof to at least one of the plurality of stakes. A support post is disposed at a distal end of each support arm. A first centering bracket is disposed between a first pair of the support posts. A second centering bracket is disposed between a second pair of the support posts.

The first and second centering brackets can be curved. The first and second centering brackets can be located radially opposite one another.

A plurality of bands can secure the stake assembly to the coiled length of landscape edging. Each of the plurality of bands can be wrapped around a respective one of the first and second centering brackets and around the coiled length of landscape edging such that each of the plurality of bands passes through the hollow center of the coiled length of landscape edging.

Each of the plurality of stakes can have an elongated body comprising a top end and an opposing bottom end. The top end can comprise an enlarged top surface to facilitate contacting the stake with a tool, and the bottom end can be pointed to aid in penetrating a ground surface. The top end can further include a securing arm configured to engage the length of landscape edging when the stake is driven into the ground surface. The top surface can be textured or ribbed.

Each stake in the stake assembly can be oriented opposite an adjacent stake in the stake assembly. At least two rows of connector segments can span between adjacent stakes in the plurality of stakes. At a point of attachment to each stake in the stake assembly, a thickness of each connector segment can be thinned or narrowed so as to be frangible from each stake to which it is connected.

Each of the first and second centering brackets can include a bracket member extending radially inward towards the plurality of stakes with a flange extending perpendicularly from the bracket member such that the flange engages an inner surface of the hollow center of the coiled landscape edging. The flange of each of the bracket members can be located such that the plurality of stakes are centered with respect to the hollow center of the coiled landscape edging. A plurality of legs can be provided to each of the first and second centering brackets. Each of the plurality of legs can extend normal to each of the first and second centering brackets and define a notch at a distal end thereof.

Also disclosed herein is a stake assembly for a landscape edging system. The stake assembly can include a plurality of stakes joined together by connector segments spanning between adjacent stakes in the plurality of stakes. A plurality of support arms can extend outwardly from the joined together plurality of stakes. Each support arm is joined on a proximal end thereof to at least one of the plurality of stakes. A support post is disposed at a distal end of each support arm. A first centering bracket is disposed between a first pair of the support posts. A second centering bracket is disposed between a second pair of the support posts.

Each stake in the stake assembly can be oriented opposite an adjacent stake in the stake assembly.

The first and second centering brackets can be located radially opposite one another. Each of the first and second centering brackets can include a bracket member extending radially inward towards the plurality of stakes with a flange extending perpendicularly from the bracket member. A plurality of legs can be provided to each of the first and second centering brackets. Each of the plurality of legs can extend normal to each of the first and second centering brackets and defines a notch at a distal end thereof.

At a point of attachment to each stake in the stake assembly, a thickness of each connector segment can be thinned or narrowed so as to be frangible from each stake to which it is connected.

Further disclosed is a method of providing a stake assembly for a landscape edging system. A plurality of stakes can be connected together by connector segments spanning between adjacent stakes in the plurality of stakes. The connected plurality of stakes can be supported atop a coiled length of landscape edging via a plurality of support arms extending outwardly from the joined together plurality of stakes, each support arm joined on a proximal end thereof to at least one of the plurality of stakes. The connected plurality of stakes can be centered with respect to the coiled length of landscape edging with a pair of oppositely-located centering brackets that engage an inner surface of the coiled length of landscape edging. The connected plurality of stakes can be secured to the coiled length of landscape edging with a plurality of bands.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of a landscape edging system in accordance with embodiments of the present invention.

FIG. 2 is another perspective view of the landscape edging system in accordance with embodiments of the present invention.

FIG. 3 is a top view of the landscape edging system of FIG. 1.

FIG. 4 is a bottom view of the landscape edging system of FIG. 1.

FIG. 5 is a first side view of the landscape edging system of FIG. 1.

FIG. 6 is a second side view of the landscape edging system of FIG. 1.

FIG. 7 is a third side view of the landscape edging system of FIG. 1.

FIG. 8 is a fourth side view of the landscape edging system of FIG. 1.

FIG. 9 is a perspective view of a stake assembly for a landscape edging system in accordance with embodiments of the present invention.

FIG. 10 is another perspective view of a stake assembly for a landscape edging system in accordance with embodiments of the present invention.

FIG. 11 is a top view of the stake assembly system of FIG. 9.

FIG. 12 is a bottom view of the stake assembly system of FIG. 9.

FIG. 13 is a first side view of the stake assembly system of FIG. 9.

FIG. 14 is a second side view of the stake assembly system of FIG. 9.

FIG. 15 is a third side view of the stake assembly system of FIG. 9.

FIG. 16 is a fourth side view of the stake assembly system of FIG. 9.

While the invention is amenable to various modifications and alternative forms, specifics thereof have been shown by way of example in the drawings and will be described in detail. It should be understood, however, that the intention is not to limit the invention to the particular exemplary embodiments described. On the contrary, the invention is to cover all modifications, equivalents, and alternatives falling within the spirit and scope of the invention as defined by the appended claims.

### DETAILED DESCRIPTION

In the following descriptions, the present invention will be explained with reference to exemplary embodiments thereof. However, these embodiments are not intended to limit the present invention to any specific example, embodiment, environment, applications, or particular implementations described in these embodiments. Therefore, description of these embodiments is only for purpose of illustration rather than to limit the present invention.

Dimensions and relative proportions of components are merely example embodiments and can be varied unless specifically limited in a given claim. Thus, the dimensions can be varied without departing from the scope of the invention.

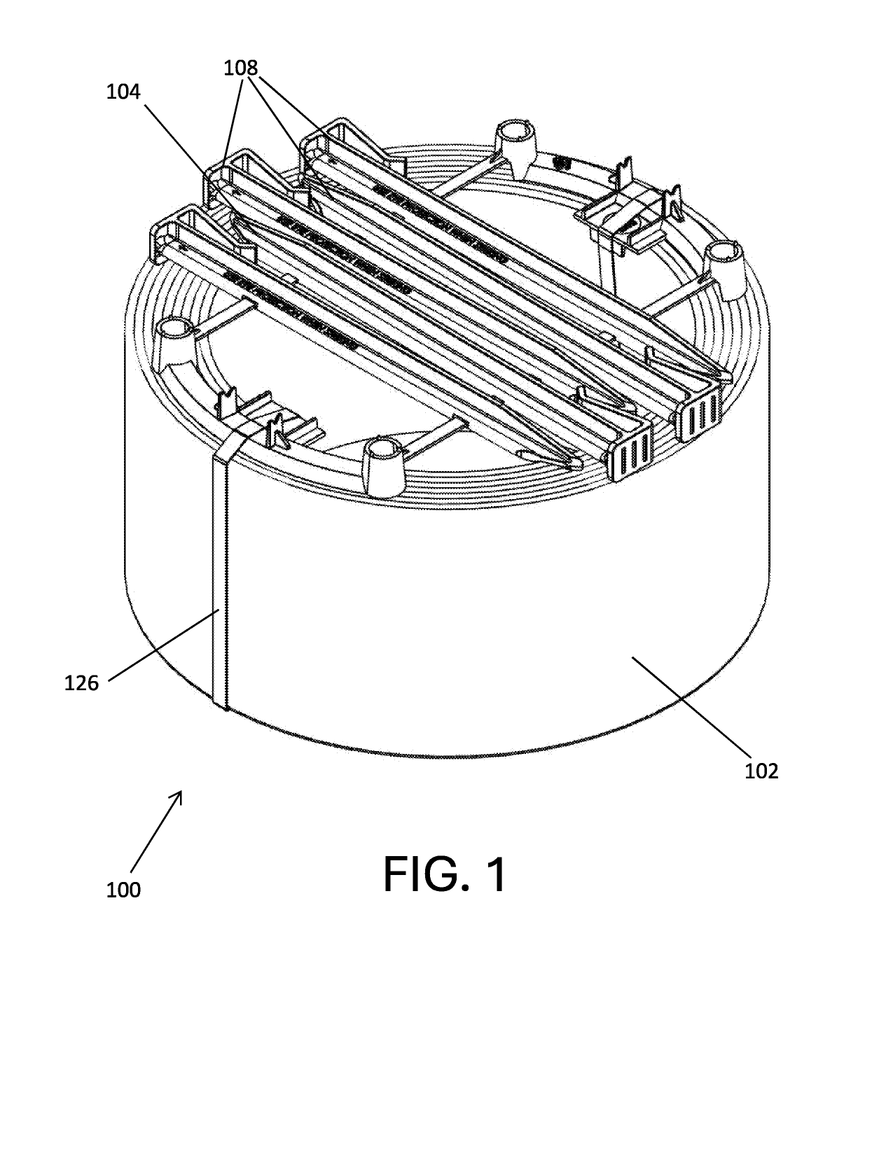

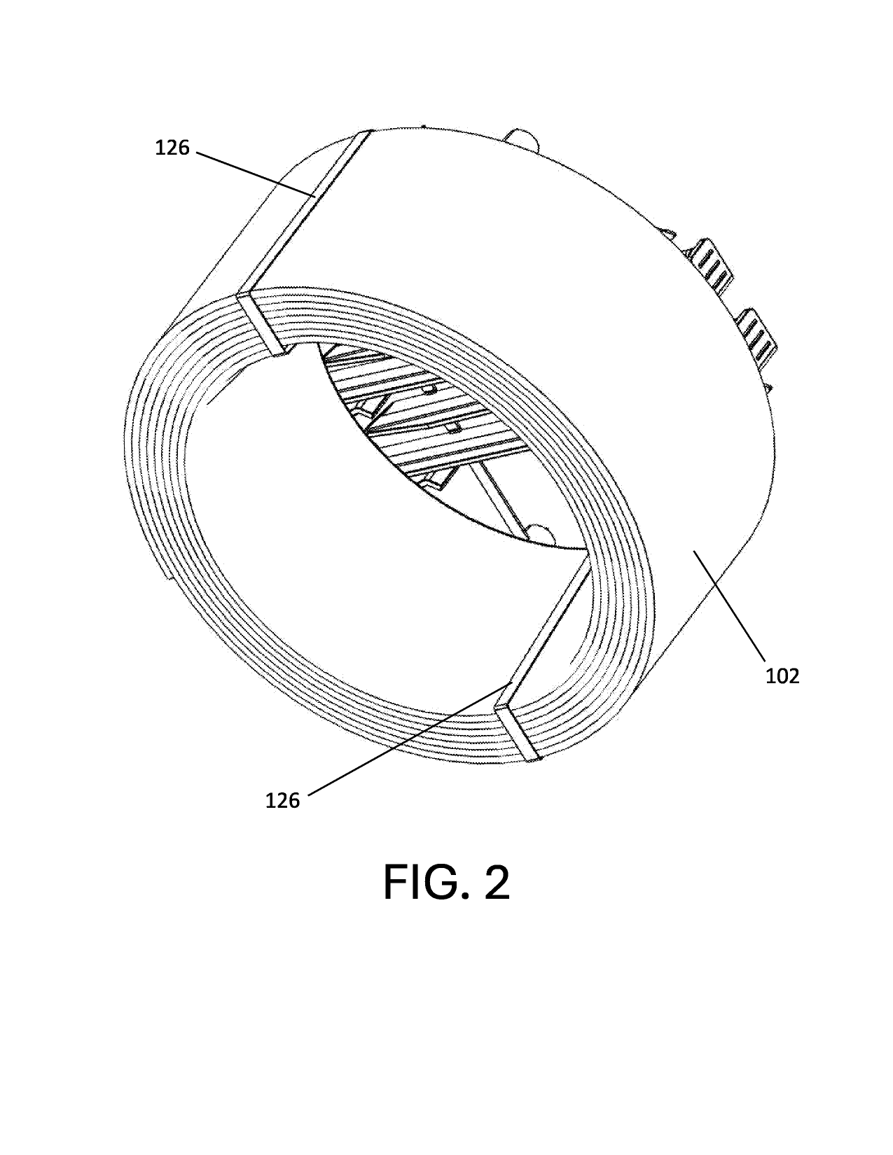

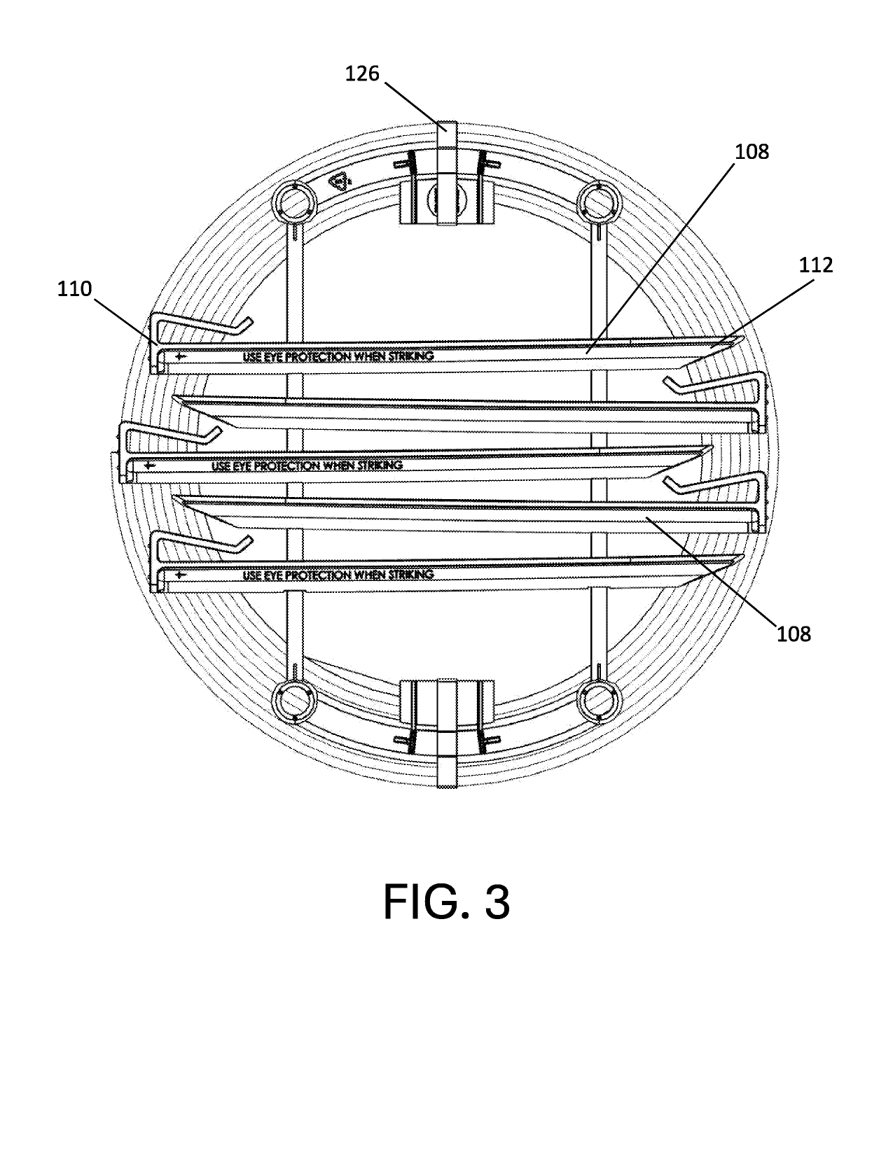

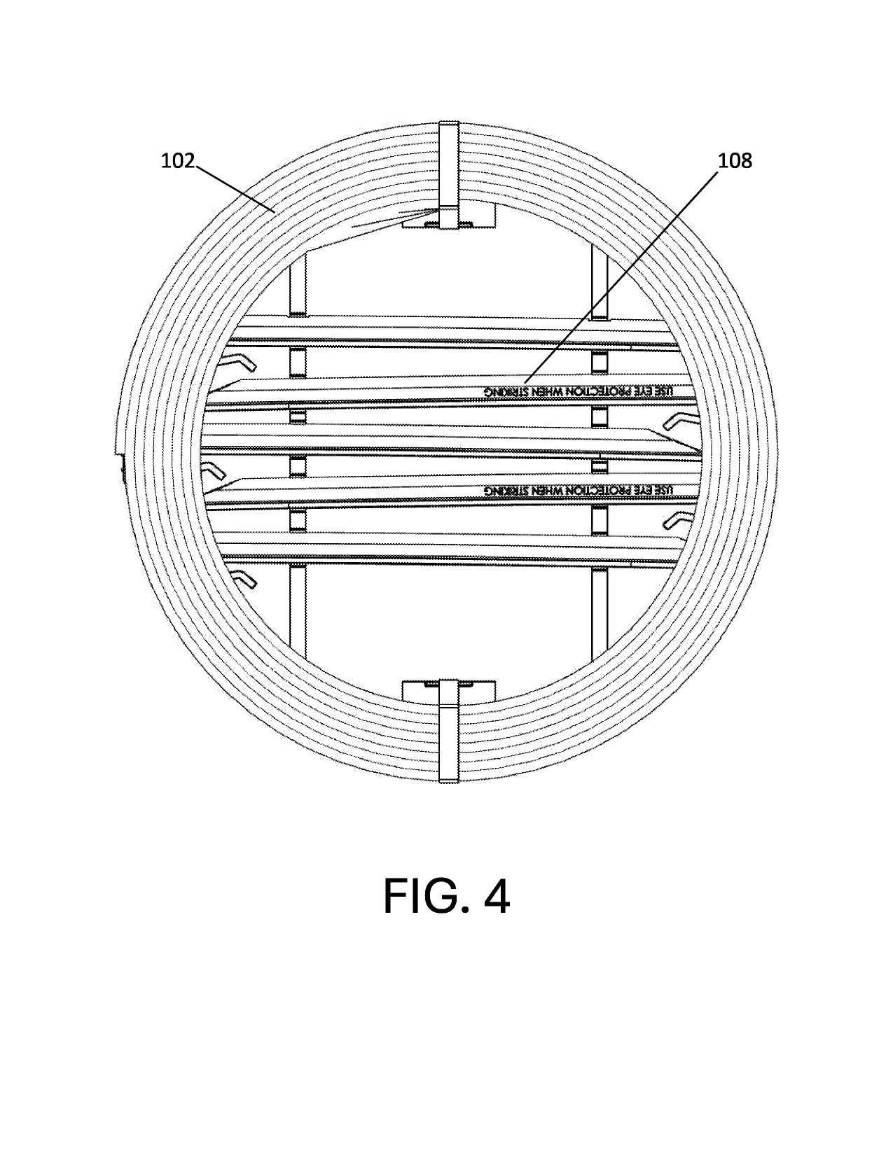

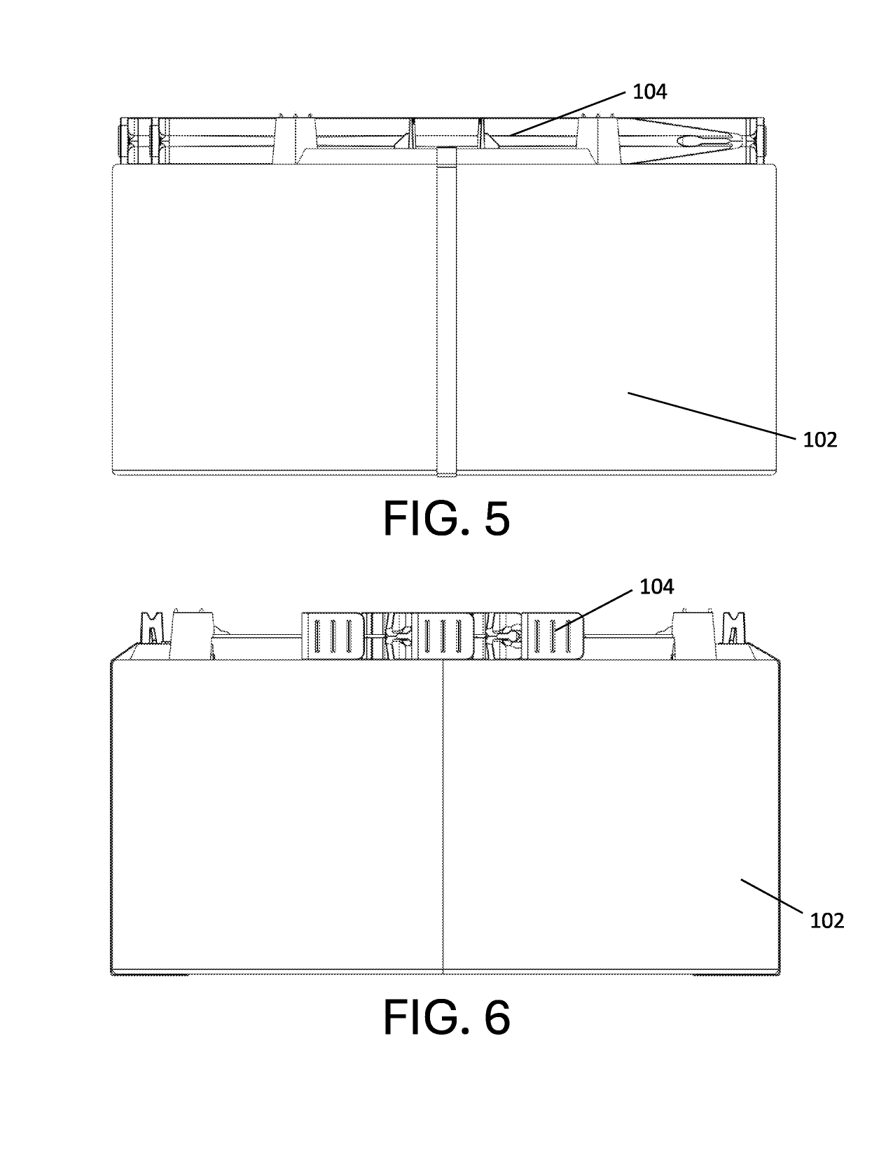

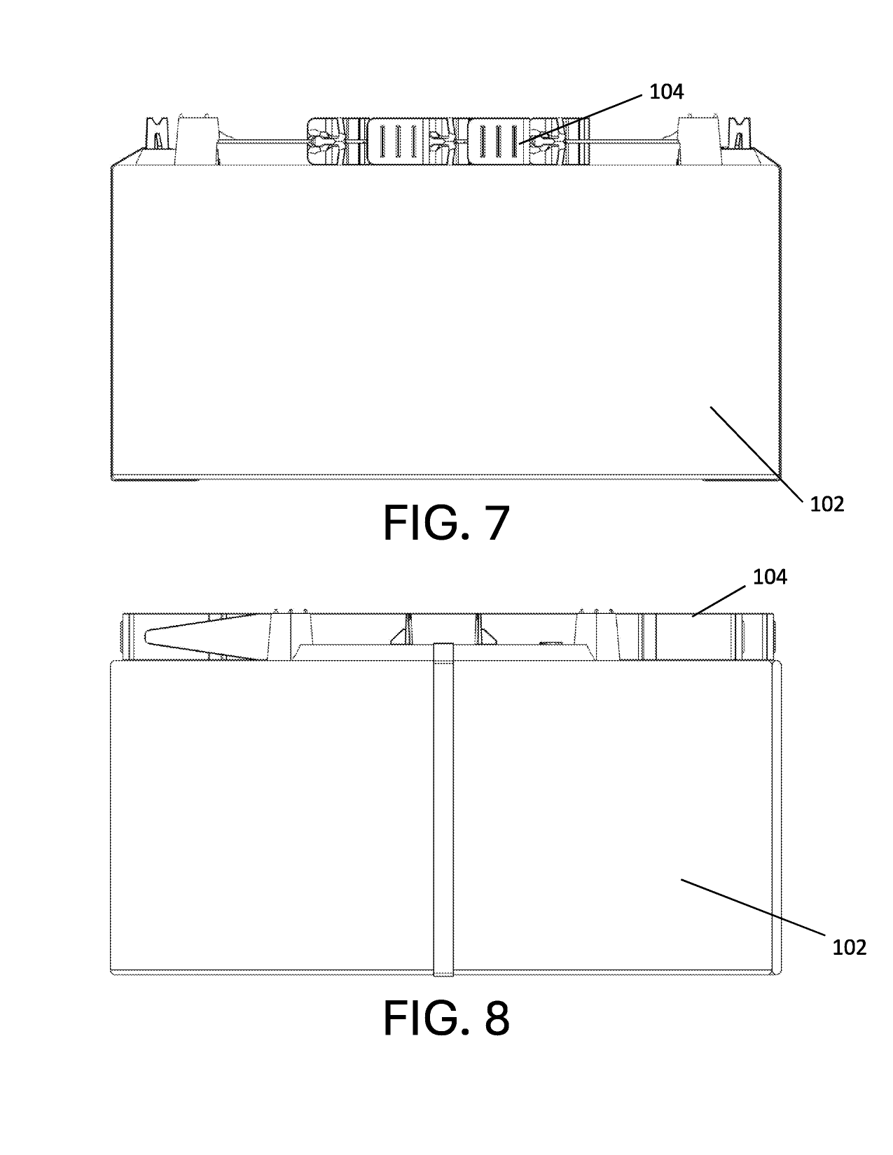

Referring generally to FIGS. 1-8, the landscape edging system 100 comprises a coiled length of edging 102 (also referred to herein as the coil or coiled edging) and a stake assembly 104 disposed on a top side of the coil 102. A plurality of bands 106 secure the stake assembly 104 to the coil 102 and keep the coil 102 from unraveling. The bands 106 can be formed from inelastic plastic straps.

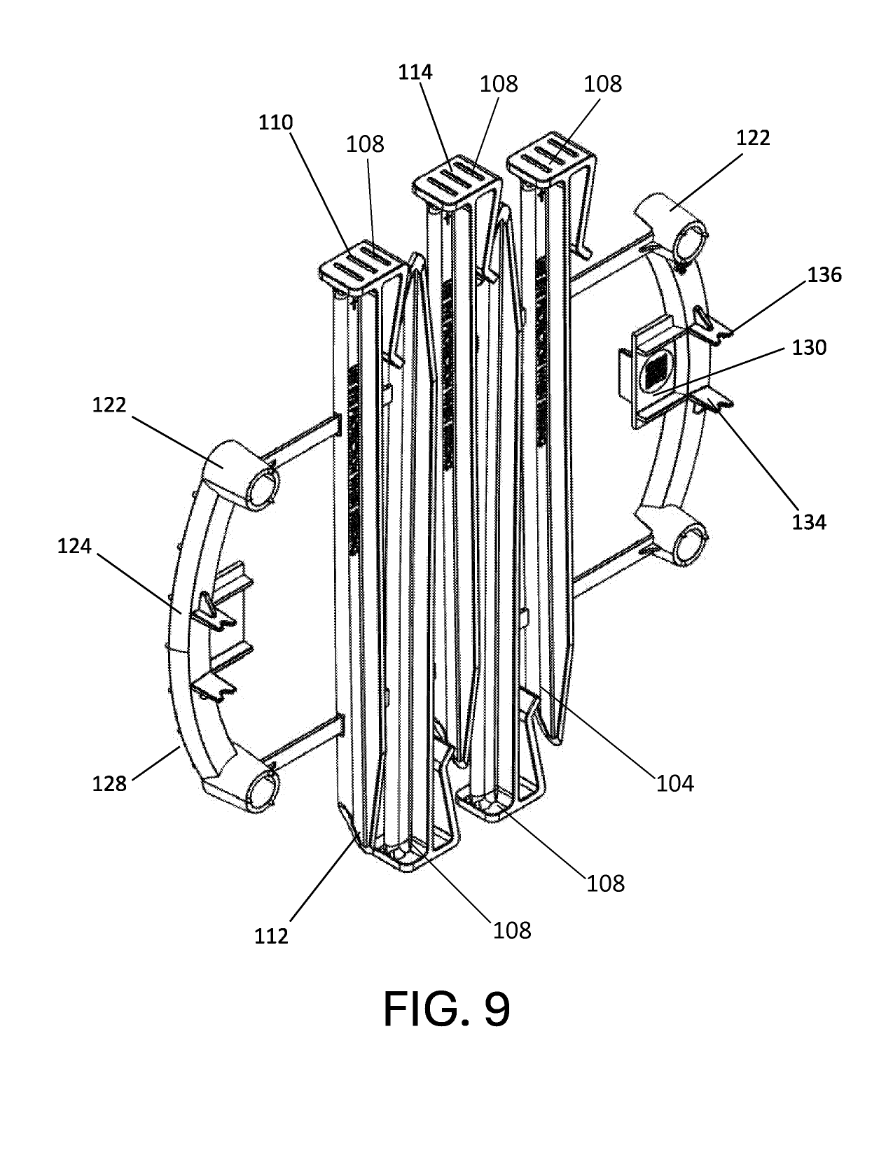

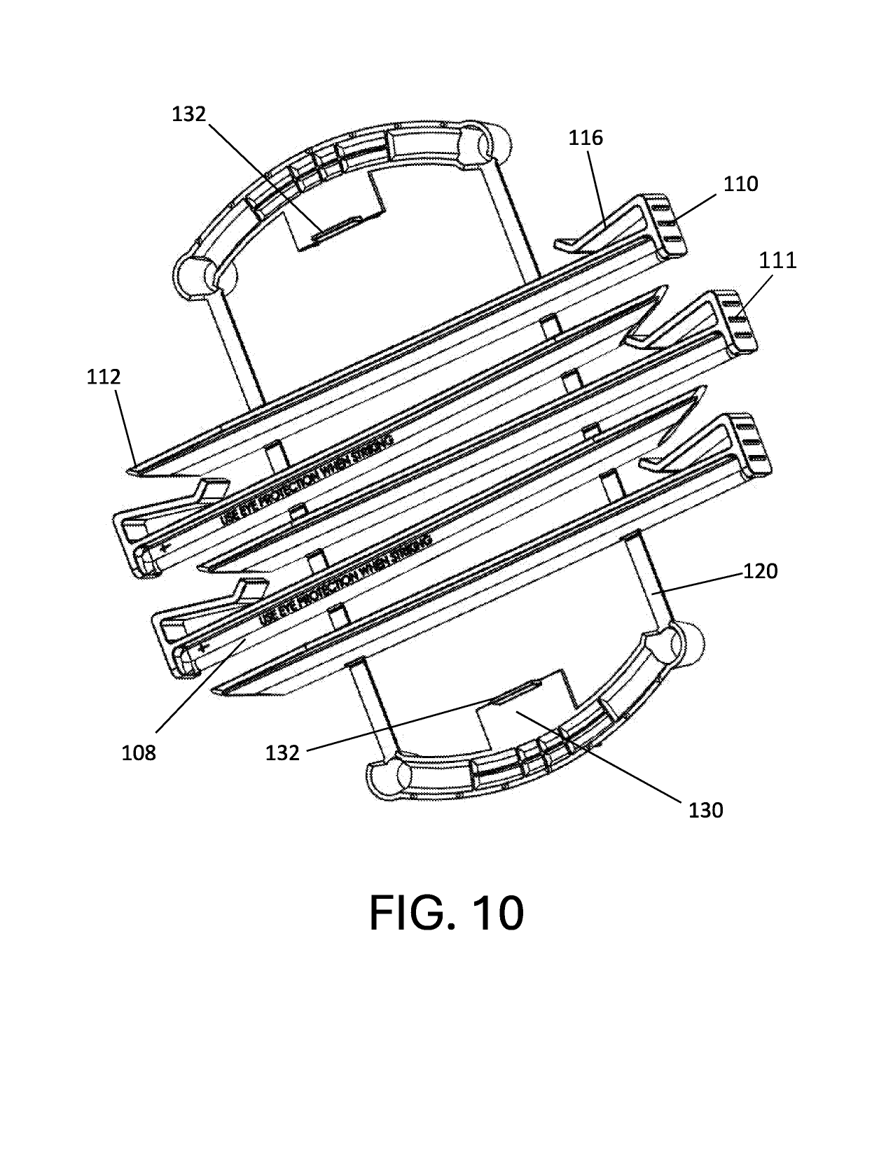

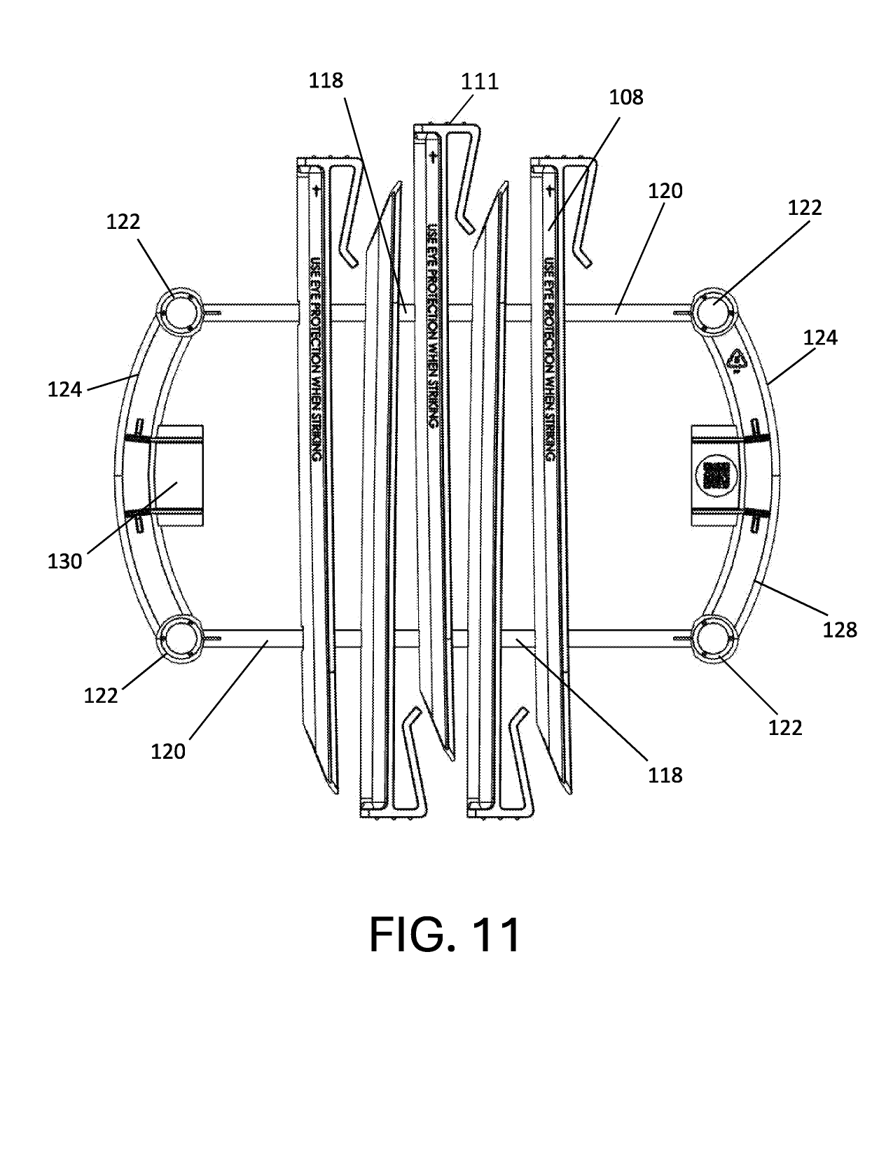

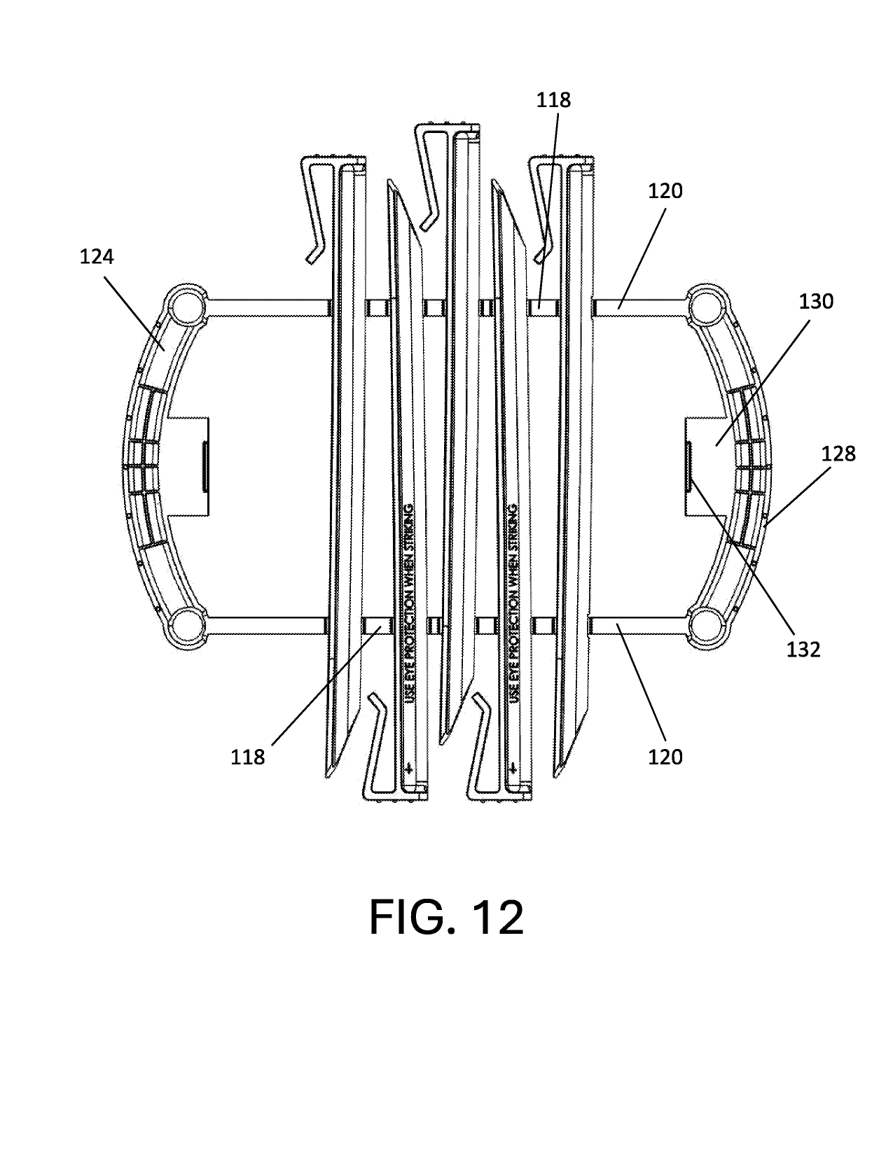

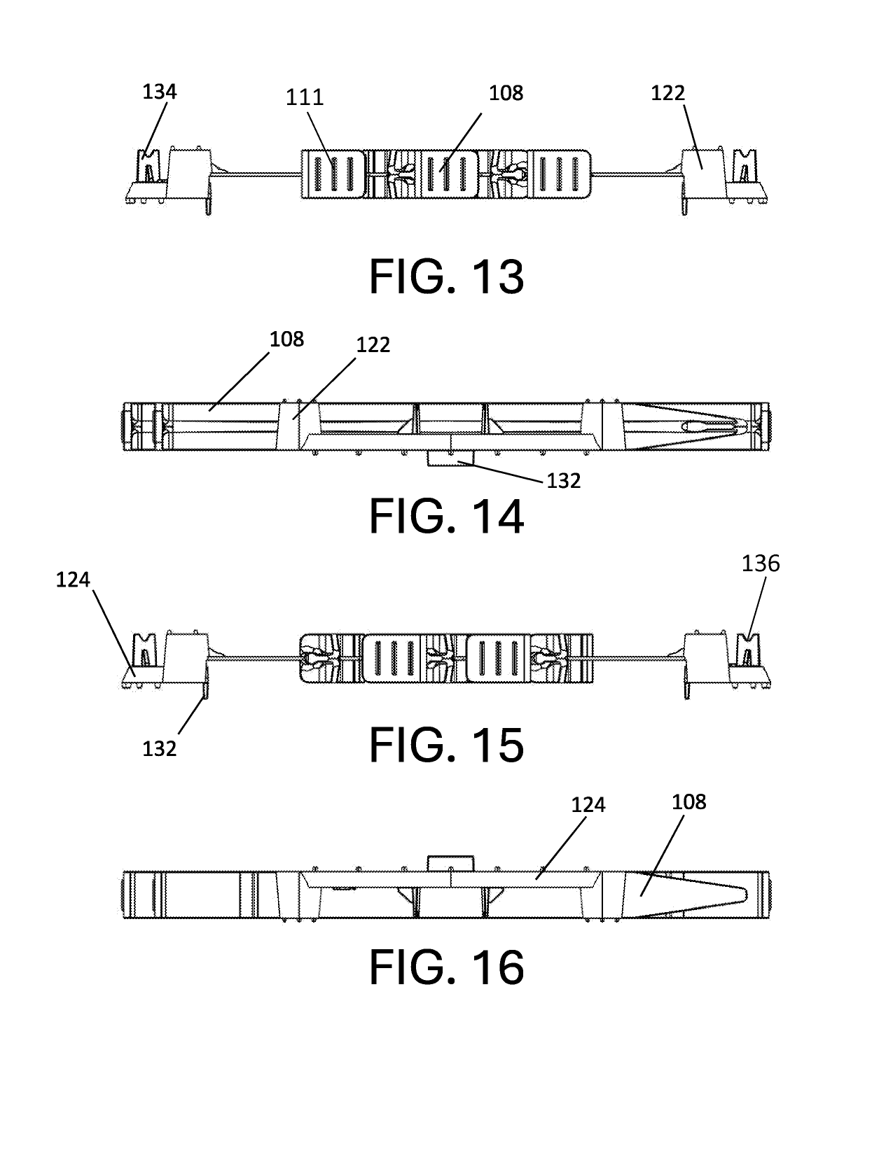

Referring additionally to FIGS. 9-16, the stake assembly 104 comprises a plurality of individual stakes 108 arranged longitudinally in a side-by-side manner while alternating directions. Each stake has a top end 110 and an opposing bottom end 112. The top end 110 comprises a top surface 114 that can be contacted with a mallet or hammer to drive the stake into the ground. The top end 110 also includes a securing arm 116 to engage the edging 102 and hold it in place once the stake 108 is driven into the ground. The top surface 111 of the top end can be textured or ribbed to minimize slippage of the striking tool during striking actions. The bottom end 112 is pointed and/or sharpened to aid in penetrating the ground.

Five stakes 108 are shown in the figures, but a greater or lesser number of stakes can be employed in the edging assembly 102 in alternative embodiments.

The stakes 108 are connected to one another by a plurality of frangible connector segments 118. The connector segments 118 are short segments of material that span between adjacent stakes 108 and attach to the longitudinal surface thereof. Two columns or rows of connector segments 118 are employed in the figures, one on each side of the mid-length point of each stake 108. This keeps the stakes longitudinally aligned. However, more or fewer columns/rows of connector segments 118 can be employed in other alternative embodiments. At the point of attachment to each stake 108, the thickness of the connector segments 118 can be thinned or narrowed to facilitate the separation of the stake from the connector segment 118 by the user.

The connector segments 118 also continue beyond the outermost stakes 108 to form support arms 120 that support the stakes 108 in a generally centered position atop the coil of edging 102. The distal ends of each of the support arms 120 comprise a cylindrical post 122. Each support post 12 is a hollow cylinder section or segment that defines the vertical spacing distance between adjacent edging system 100 units when vertically stacked atop one another. The stacking of edging system 100 units can be directly vertical columns or partially offset from row to row. Since there are four such posts 122 in the depicted example, and each post 122 has the same height, the edging system 100 units will define generally parallel rows when vertically stacked.

A further feature of the stake assembly 104 is the pair of centering brackets 124 that function to keep the stakes 108 centered atop the coil 102 and to provide a suitable location for attachment of the bands 126 that secure the stake assembly 104 to the coil and keep the coil from unraveling. The centering brackets 124 each comprise an arcuate section 128 spanning between two adjacent posts 122. Centered on each arcuate section 128 is a bracket member 130 extending radially inward from the arcuate section 128. A downward facing flange 132 extends from the bracket member 130 to engage the inner surface of the coil of edging to keep the stake assembly 104 centered with respect to the center of the coil 102.

In addition, a plurality of legs 134 can extend vertically upwards from the arcuate section to further support the weight of additional edging system 100 units stacked vertically on top of a given edging system unit. The upper edge of each leg 134 can be notched 136 or shaped to engage the bottom of another coil of edging 102 stacked on top of the edging unit. The notching 136 resists horizontal movement of one of the edging system 100 units relative to the other when vertically stacked.

The coiled edging 102 can be formed from a plastic material as part of an extrusion process. Other materials and manufacturing processes can be employed as well.

The stake assembly 104 can be formed of a rigid plastic material. A molding operation can be used to form the stake assembly. Other materials and manufacturing processes can be employed as well.

The bands 126 are non-stretchable straps or bands that are wrapped around the coil 102 and stake assembly 104, and then fastened back on itself to form a secured loop.

In use, the bands 126 are removed from the edging system unit. The stake assembly 104 is lifted away from the coil 102 and the individual stakes 108 are separated from the connector segments 118. The edging 102 and stakes 108 are then installed as one would normally use coiled edging and corresponding securing stakes.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A landscape edging system, comprising:
a length of landscape edging formed into a coil with a hollow center; and
a stake assembly secured to the coiled length of landscape edging, the stake assembly comprising:
a plurality of stakes joined together by connector segments spanning between
adjacent stakes in the plurality of stakes;
a plurality of support arms extending outwardly from the joined together
plurality of stakes, each support arm joined on a proximal end thereof to at least one of the plurality of stakes;
a support post disposed at a distal end of each support arm;
a first centering bracket disposed between a first pair of the support posts; and
a second centering bracket disposed between a second pair of the support posts.

2. The landscape edging system of claim 1, wherein the first and second centering brackets are curved.

3. The landscape edging system of claim 1, wherein the first and second centering brackets are located radially opposite one another.

4. The landscape edging system of claim 1, further comprising a plurality of bands, wherein the plurality of bands secure the stake assembly to the coiled length of landscape edging.

5. The landscape edging system of claim 4, wherein each of the plurality of bands is wrapped around a respective one of the first and second centering brackets and around the coiled length of landscape edging such that each of the plurality of bands passes through the hollow center of the coiled length of landscape edging.

6. The landscape edging system of claim 1, wherein each of the plurality of stakes has an elongated body comprising a top end and an opposing bottom end, wherein the top end comprises an enlarged top surface to facilitate contacting by a tool, and wherein the bottom end is pointed to aid in penetrating a ground surface.

7. The landscape edging system of claim 6, wherein the top end further includes a securing arm configured to engage the length of landscape edging when the stake is driven into the ground surface.

8. The landscape edging system of claim 6, wherein the top surface is textured or ribbed.

9. The landscape edging system of claim 1, wherein each stake in the stake assembly is oriented opposite an adjacent stake in the stake assembly.

10. The landscape edging system of claim 1, further comprising at least two rows of connector segments spanning between adjacent stakes in the plurality of stakes.

11. The landscape edging system of claim 1, wherein at a point of attachment to each stake in the stake assembly, a thickness of each connector segment is thinned or narrowed so as to be frangible from each stake to which it is connected.

12. The landscape edging system of claim 1, wherein each of the first and second centering brackets includes a bracket member extending radially inward towards the plurality of stakes with a flange extending perpendicularly from the bracket member such that the flange engages an inner surface of the hollow center of the coiled landscape edging.

13. The landscape edging system of claim 12, wherein the flange of each of the bracket members is located such that the plurality of stakes are centered with respect to the hollow center of the coiled landscape edging.

14. The landscape edging system of claim 12, further comprising a plurality of legs provided to each of the first and second centering brackets, wherein each of the plurality of legs extends normal to each of the first and second centering brackets and defines a notch at a distal end thereof.

15. A stake assembly for a landscape edging system, the stake assembly comprising:
a plurality of stakes joined together by connector segments spanning between adjacent
stakes in the plurality of stakes;
a plurality of support arms extending outwardly from the joined together plurality of
stakes, each support arm joined on a proximal end thereof to at least one of the plurality of stakes;
a support post disposed at a distal end of each support arm;
a first centering bracket disposed between a first pair of the support posts; and
a second centering bracket disposed between a second pair of the support posts.

16. The stake assembly of claim 15, wherein each stake in the stake assembly is oriented opposite an adjacent stake in the stake assembly.

17. The stake assembly of claim 15, wherein the first and second centering brackets are located radially opposite one another, and wherein each of the first and second centering brackets includes a bracket member extending radially inward towards the plurality of stakes with a flange extending perpendicularly from the bracket member.

18. The stake assembly of claim 17, further comprising a plurality of legs provided to each of the first and second centering brackets, wherein each of the plurality of legs extends normal to each of the first and second centering brackets and defines a notch at a distal end thereof.

19. The stake assembly of claim 15, wherein at a point of attachment to each stake in the stake assembly, a thickness of each connector segment is thinned or narrowed so as to be frangible from each stake to which it is connected.

20. A method of providing a stake assembly for a landscape edging system, the method comprising:
connecting a plurality of stakes together by connector segments spanning between
adjacent stakes in the plurality of stakes;
supporting the connected plurality of stakes atop a coiled length of landscape edging via a plurality of support arms extending outwardly from the joined together plurality of
stakes, each support arm joined on a proximal end thereof to at least one of the plurality of stakes;
centering the connected plurality of stakes with respect to the coiled length of
landscape edging with a pair of oppositely-located centering brackets that engage an inner surface of the coiled length of landscape edging; and
securing the connected plurality of stakes to the coiled length of landscape edging with
a plurality of bands.
